(19) United States
(12) Patent Application Publication
(10) Pub. No.: US 2013/0043789 A1
(43) Pub. Date: Feb. 21, 2013

(54) SCREW-IN LED BULB

(71) Applicant: ilumisys, Inc., Troy, MI (US)

(72) Inventors: DAVID L. SIMON, Grosse Pointe Woods, MI (US); JOHN IVEY, Farmington Hills, MI (US); MICHAEL A. WHITE, Beverly Hills, MI (US)

(73) Assignee: ILUMISYS, INC., Troy, MI (US)

(21) Appl. No.: 13/656,966

(22) Filed: Oct. 22, 2012

Related U.S. Application Data
(63) Continuation of application No. 12/791,122, filed on Jun. 1, 2010, now Pat. No. 8,299,695.
(60) Provisional application No. 61/183,307, filed on Jun. 2, 2009.

(51) Int. Cl. H05B 33/02; H05B 37/00

(52) U.S. Cl. 315/113; 313/46; 313/35

(57) ABSTRACT

An LED-based light can include a highly thermally conductive base having multiple radially outward projecting nodes. The nodes can be spaced apart in an axial and circumferential directions of the base. The base can include recessed channels between the nodes to enable airflow in multiple directions about the base. An electrical connector and at least one LED can be attached to the base, and a light transmitting bulb can be attached to the base and can cover the at least one LED. The geometry of the base can promote heat dissipation, which can allow the at least one LED to use enough power to produce an amount of luminosity that allows the LED-based light to replicate, for example, an incandescent light without overheating.

### STATEMENT OF RELATED CASES

This application is a continuation application of U.S. application Ser. No. 12/791,122, filed Jun. 1, 2010, which in turn claims priority to Provisional Application No. 61/183,307, filed Jun. 2, 2009, both of which are hereby incorporated by reference in their entireties.

### BACKGROUND

Incandescent light bulbs are commonly used in many environments, such as households, commercial buildings, and advertisements, and in many types of fixtures, such as desk lamps and overhead fixtures. Incandescent bulbs can have a threaded electrical connector for use in Edison-type fixtures, though incandescent bulbs can include other types of electrical connectors such as a bayonet or pin electrical connector. Incandescent light bulbs generally consume large amounts of energy and have short life-spans. Indeed, many countries have begun phasing out or plan to phase out the use of incandescent light bulbs entirely.

Compact fluorescent light bulbs (CFLs) are gaining popularity as replacements for incandescent light bulbs. CFLs are typically much more energy efficient than incandescent light bulbs, and CFLs typically have much longer life-spans than incandescent light bulbs. However, CFLs contain mercury, a toxic chemical, which makes disposal of CFLs difficult. Additionally, CFLs require a momentary start-up period before producing light, and many consumers do not find CFLs to produce light of similar quality to incandescent bulbs. Further, CFLs are often larger than incandescent lights of similar luminosity, and some consumers find CFLs unsightly when not lit.

Known LED-based light bulbs have been developed as an alternative to both incandescent light bulbs and CFLs. Known LED light bulbs typically each include a base that functions as a heat sink and also include an electrical connector at one end, a group of LEDs attached to the base, and a bulb. The bulb often has a semi-circular shape with its widest portion attached to the base such that the bulb protects the LEDs.

### SUMMARY

Known LED-based light bulbs suffer from multiple drawbacks. A base of a typical known LED-based light bulb is unable to dissipate a large amount of heat, which in turn limits the amount of power that can be supplied to LEDs in the known LED-based light bulb without a high risk of the LEDs overheating. As a result of the power supplied to the LEDs being limited, the typical known LED-based light bulb has a limited luminosity and as a result is not as bright as an incandescent light bulb that the LED-based light bulb is intended to replace.

In an effort to increase the luminosity of known LED-based light bulbs, some known LED-based light bulbs include over-sized bases having large surface areas. The large surface areas of the over-sized bases are intended to allow the bases to dissipate sufficient amounts of heat such that the LEDs of each known LED-based light can be provided with enough power to produce as much luminosity as the respective incandescent bulbs that these known LED-based light bulbs are intended to replace. However, the total size of one of the LED-based lights is often limited, such as due to a fixture size constraint. For example, a desk lamp may only be able to accept a bulb having a three to four inch diameter, in which case the over-sized base of an LED-based light should not exceed three to four inches in diameter. Thus, the size of the over-sized base for the known LED-based light bulb is constrained, and heat dissipation remains problematic.

Further, the use of over-sized bases in some known LED-based light bulbs detracts from the distributions of light emanating from the bulbs. That is, for a typical known LED-based light bulb having one of the over-sized bases, the over-sized base has a diameter as large as or larger than a maximum diameter of the bulb of the known LED-based light bulb. As a result of its small bulb diameter to base diameter ratio, the base blocks light that has been reflected by the bulb and that would otherwise travel in a direction toward an electrical connector at an end of the base. The typical known LED-based light bulb thus does not direct much light in a direction toward the electrical connector. For example, when the typical known LED-based light bulb having an over-sized base is installed in a lamp or other fixture in which the bulb is oriented with its base below its bulb, very little light is directed downward. Thus, the use of over-sized bases can also prevent known LED-based lights from closely replicating the distribution of incandescent bulbs.

As an alternative to using over-sized bases, other attempts have been made to increase the ability of known LED-based light bulbs to dissipate heat. For example, bases of some known LED-based light bulbs include motorized fans for increasing the amounts of airflow experienced by the bases. However, known LED-based light bulbs including fans often produce audible noises and are expensive to produce. As another example of an alternative to using an over-sized base, bases of some known LED-based lights have been provided with axially (e.g., if the LED-based light is intended to replace a conventional incandescent bulb, then the axial direction is from an end of the Edison-type connector opposite the bulb along the major length of the bulb to an opposing end of the light) extending ribs in an attempt to increase the surface areas of the bases without too greatly increasing the diameters of the bases. However, such ribs often have the effect of acting as a barrier to air flow and, as a result, tend to stall air flow relative to the base. As a result, bases with axially extending ribs typically do not provide a sufficient amount of heat dissipation.

Examples of a screw-in LED bulb described herein have many advantages over known LED-based light bulbs. For example, an example of a screw-in LED bulb as described herein can include a base with a plurality of nodes, and channels between the nodes can extend about the base in multiple directions, such as axially and circumferentially. The nodes can increase the surface area of the base, thereby improving the conductive heat dissipation abilities of the base, and the geometry of the base can enhance airflow relative to the base, thereby improving the convective heat dissipation abilities of the base. The base can thus dissipate a sufficient amount of energy for the screw-in LED bulb to produce as much light as a known incandescent bulb.

The exact geometry of the base can be determined using, as an example, fluid dynamics software. The material of the base, the amount of heat produced by LEDs in the screw-in LED bulb, and the temperature at which the LEDs safely operate can be among the considerations used to determine the geometry of the base. Additionally, the base can be shaped to improve airflow, thus improving convective heat transfer, and both the speed and direction of airflow can be considered. Airflow at the time the bulb is initially turned on, airflow between the time at which the screw-in LED bulb is initially turned on and the time at which the screw-in LED bulb reaches steady state operation, and airflow at the time at which steady state operation of the screw-in LED bulb has been reached can all be considered to determine the geometry of the base.

Additionally, the nodes can be shaped to allow for easy manufacturing of the base using die casting. A die can be made in sections or pieces, and the die pieces can be arranged to contact one another to form a mold cavity having the shape of the base. Liquid material, e.g., molten aluminum, can be poured into the mold cavity, and the liquid material can be allowed to cool to form the base. The die pieces can be pulled away from the formed base in different directions, such as in four directions angled approximately ninety degrees from one another. Thus, the nodes can be shaped to not interfere with removal of the die pieces.

The geometry of the base relative to a geometry of a bulb of the screw-in LED bulb can be set such that the light distribution from the screw-in LED bulb closely replicates the distribution of light from an incandescent bulb. A maximum width of the bulb measured perpendicularly to an axial direction of the base can be about 120% or more of a maximum diameter of the base, and a height of the bulb measured along the axial direction of the base can be about equal to the maximum width of the bulb or greater than the maximum width of the bulb. These ratios can allow the bulb to distribute light in a direction toward an electrical connector at an end of the base opposite the bulb and for light to disperse prior to contacting the bulb to reduce the appearance of a bright spot. Also, a portion of the bulb that is in the path of a high amount of light can be coated or otherwise modified to reduce its transmissiveness, thereby directing light toward portions of the bulb that would otherwise receive only a low amount of light.

### BRIEF DESCRIPTION OF THE DRAWINGS

The description herein makes reference to the accompanying drawings wherein like reference numerals refer to like parts throughout the several views, and wherein:

FIG. 1 is a perspective view of a first example of a screw-in LED bulb;

FIG. 2 is a top plan view of the screw-in LED bulb of FIG. 1;

FIG. 3 is a bottom plan view of the screw-in LED bulb of FIG. 1 without its electrical connector and with its bulb shown in phantom;

FIG. 4 is a bottom plan view of a base of the screw-in LED bulb of FIG. 1 along with die pieces used to form the base; and

FIG. 5 is a perspective view of a second example of a screw-in LED bulb.

### DESCRIPTION

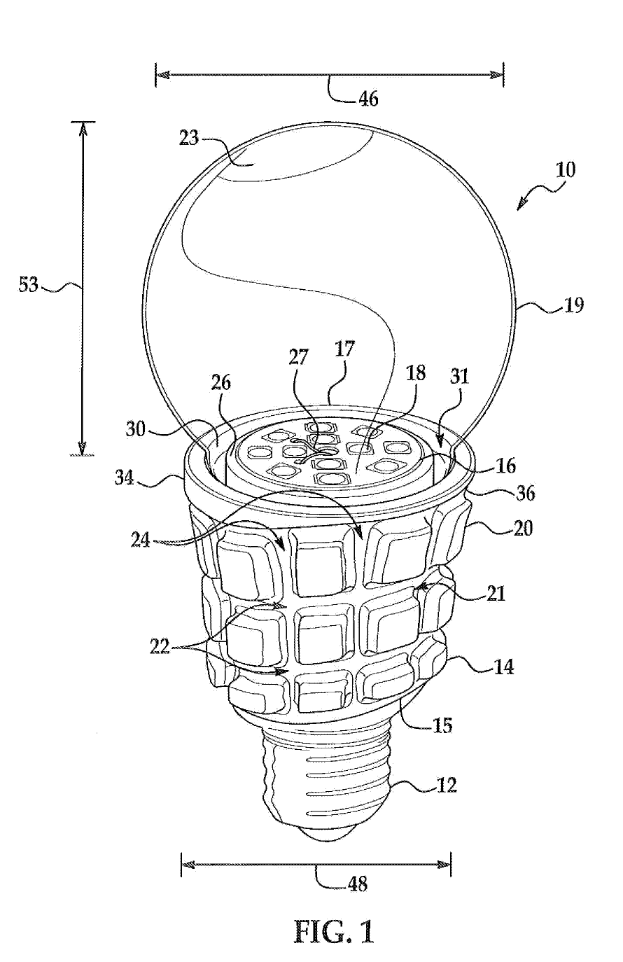

Examples of LED-based light bulbs are discussed herein with reference to FIGS. 1-5. A first example of a screw-in LED bulb 10 shown in FIG. 1 can include an electrical connector 12, a base 14 attached to the electrical connector 12, a circuit board 16 attached to the base 14, a plurality of LEDs 18 mounted on the circuit board 16, and a bulb 19 connected to the base 14 and covering the LEDs 18.

The electrical connector 12 can be of the screw-in type, also referred to as an Edison connector. The electrical connector 12 can alternatively be of another type such as a bayonet connector or pin connector. The electrical connector 12 can serve as an electrical and physical connection between the bulb 10 and a fixture, such as a desk lamp or an overhead fixture. The electrical connector 12 can be screwed, snap-fit, glued, or otherwise attached to a first end 15 of the base 14.

Referring still to FIG. 1, the base 14 can act as a heat sink for dissipating heat produced by the LEDs 18. The base 14 can be made from a highly thermally conductive metal such as aluminum, a highly thermally conductive plastic, or another highly thermally conductive material. How thermally conductive the material from which the base 14 is constructed should be can be determined based on, for example, the amount of heat that is to be dissipated and the geometry of the base 14. The base 14 can be painted, powder-coated, or anodized to improve its thermal emissivity. For example, a thermally conductive, high emissivity paint (e.g., a paint having an emissivity of greater than 0.5) can be applied to at least a portion of an exterior of the base 14.

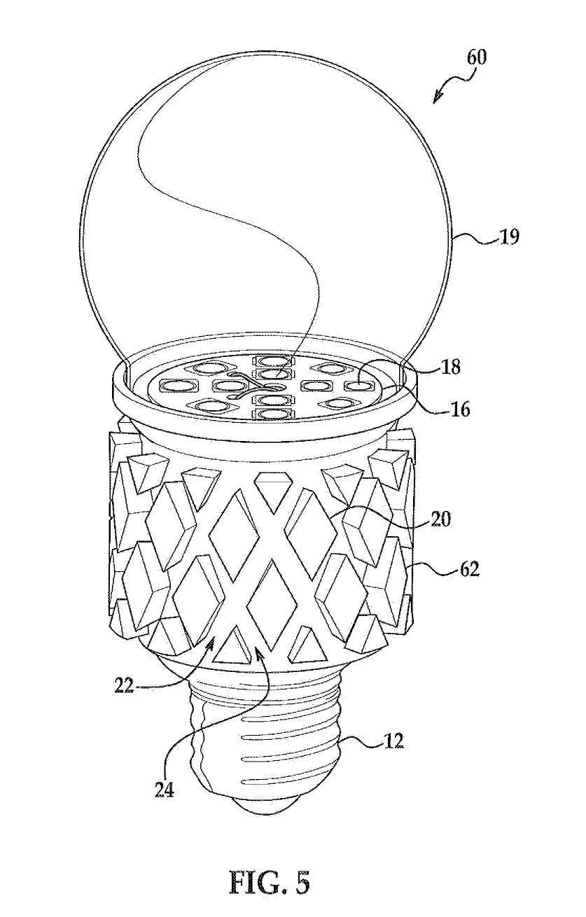

The base 14 can define a plurality of raised nodes 20 projecting radially outward from an exterior surface 21 of the base 14. The nodes 20 can have a generally rectangular shape as shown in FIG. 1, a diamond shape as shown in FIG. 5, or some other shape (e.g., oval, triangular, or polygonal). The nodes 20 can be arranged generally in rows and columns as shown in FIG. 1 to define channels 22 and 24. While the channels 22 and 24 extend generally circumferentially and axially, respectively, relative to the base 14 as shown in FIG. 1, the channels 22 and 24 can be oriented differently depending on the shape and position of the nodes 20. For example, as shown in FIG. 5, the channels 22 and 24 are angled approximately forty five degrees relative the circumferential and axial directions, respectively. The nodes 20 can have rounded edges at the junctions of proximal ends of the nodes 20 and the surface 21, at the junctions between different sides of the nodes 20 that extend between the proximal and distal ends of the nodes 20, and at the junctions between the sides of the nodes 20 and the distal ends of the nodes 20. The rounded edges of the nodes 20 can encourage airflow over the base 14, as rounded edges can enable greater airflow compared to sharp edges by reducing the tendency of air to stall.

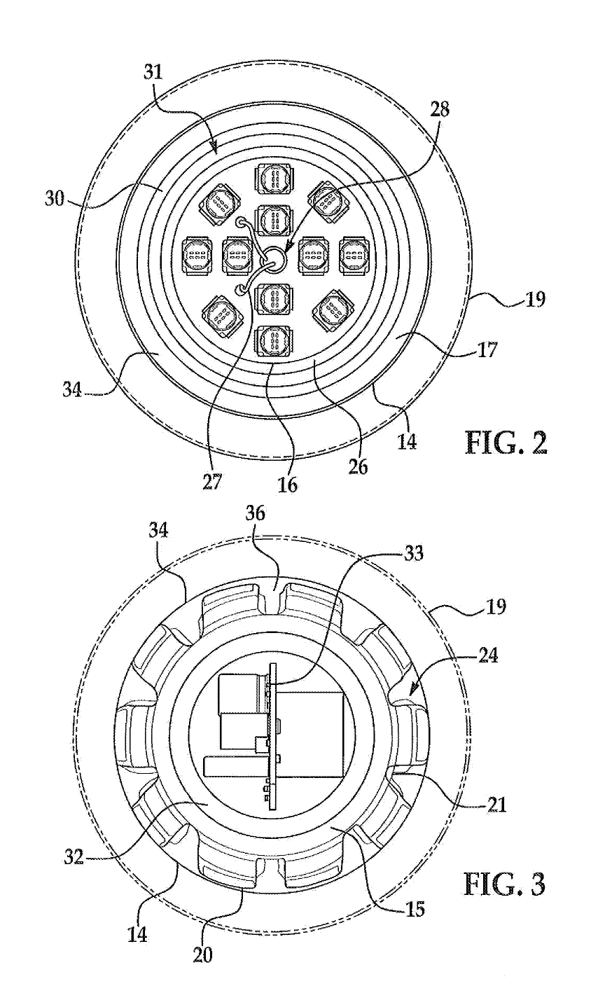

Referring now to FIG. 2, a second end 17 of the base 14 axially opposite the first end 15 can define a platform 26 for receiving the circuit board 16. The platform 26 can be generally planar and can define an aperture 28 through which wiring 27 that is in electrical communication with the electrical connector 12 and the circuit board 16 can pass. A wall 30 can extend circumferentially around the platform 26. While the wall 30 is shown as continuous, the wall 30 can alternatively be discontinuous. The wall 30 can be obtusely angled relative to the platform 26 such that an angle between, for example, 90 and 135 degrees is formed therebetween. The wall 30 can enhance an attachment between the base 14 and bulb 19 by providing a surface to which the bulb 19 can be attached. A recessed groove 31 can be defined by the second end 17 of the base 14 about the platform 26 and radially inward of the wall 30.

Referring again to FIG. 1, a ridge 34 can extend radially outward and axially toward the nodes 20 from the second end 17 of the base 14. The length of the ridge 34 in the axial direction of the base 12 can vary circumferentially around the base 12 as shown in FIG. 1. For example, the axial length of the ridge 34 can vary such that the distance between the ridge 34 and adjacent nodes 20 remains substantially constant around the base 14 even if the positions of the nodes 20 are staggered in the axial direction. A fillet 36 can be included between the ridge 34 and the surface 21 of the base 14 as shown in FIG. 1. The fillet 36 can improve airflow between the ridge 34 and the nodes 20 and surface 21.

The base 14 can also define a cavity 32 as shown in FIG. 3. The cavity 32 can be sized to receive electronics 33 that, as an example, convert AC power received from the electrical connector 12 to DC power that is supplied to the LEDs 18. The electronics 33 can be electrically coupled to the electric connector 12, and the wiring 27 can extend from the electronics 33 to the circuit board 16. The electronics 33 can include, for example, a rectifier, a filtering capacitor, and DC to DC conversion circuitry. The electronics 33 can be loosely inserted into the cavity 32 and held in place as a result of the electric connector 12 enclosing the cavity 32. Alternatively, the electronics 33 can be adhered, clipped, or otherwise attached to the base 14. While the illustrated cavity 32 is cylindrical, the cavity 32 can have an alternative shape, such as a conical shape or an oval shape.

Currently, the size of the electronics 33 can be a constraint on the size of the base 14. As an example, a minimum diameter of the base 14 can be constrained such that the base 14 is of sufficient size to define the cavity 32 that in turn is of sufficient size for receiving the electronics 33. Additionally, a maximum size of the base 14, both in terms of its axial length and diameter, can be constrained by a size of a fixture in which the screw-in LED bulb 10 may be installed in. For example, the screw-in LED bulb 10 can be constrained not to exceed the length and diameter of an incandescent light bulb that the screw-in LED bulb 10 is intended to replace. Further, the maximum size of the base 14, also both in terms of its axial length and diameter, can be constrained to achieve a distribution of light that closely replicates a distribution of light from an incandescent bulb as is explained below in greater detail with respect to the ratio between the dimensions of the base 14 and the dimensions of the bulb 19. Whether or not the distribution of light from the screw-in LED bulb 10 closely replicates the distribution of light from an incandescent bulb can be judged by luminosity measuring tools, by the preferences of ordinary users, or in another manner. In addition to the above mentioned constraints, other factor can be taken into consideration when determining the geometry of the base 14, such as the expected amount of heat output by the LEDs 18, a maximum temperature at which the LEDs 18 operate safely, and the material of from which the base 14 is constructed.

Also, when determining the geometry of the base 14, both conductive and convective heat dissipation can be considered. The base 14, or certain portions therefore, can become hotter than ambient air during operation, and as a result air adjacent to hot portions of the base 14 can become hotter than air spaced from the base 14. A temperature gradient between air adjacent to the base 14 and air spaced from the base 14 can result in airflow, which in turn can provide convective heat dissipation that can aid in the dissipation of heat from the base 14. Multiple aspects of convective heat dissipation can be considered when determining the geometry of the base 14, including air speed and airflow direction. Additionally, airflow generated by the temperature gradients explained above can be considered at different time periods when determining the geometry of the base 14, such as when the screw-in LED bulb 10 is turned on, a dynamic period when the screw-in LED bulb 10 is increasing in temperature after being turned on but before reaching a steady state temperature, and when the screw-in LED bulb 10 reaches a steady state temperature. The channels 22 and 24 formed between the nodes 20 can greatly improve convective heat dissipation by allowing airflow in different directions, and the orientation of the channels 22 and 24 can be selected to encourage airflow.

Working under the above-mentioned constraints and considerations, the geometry of the base 14 can be determined such that the base 14 can dissipate a sufficient amount of heat for safe operation of the LEDs 18 at a specified power level (e.g., a power level at which the LEDs 18 produce a sufficient amount of light for the screw-in LED bulb 10 to replicate a certain incandescent bulb, such as a 60 W or 100 W incandescent bulb, that the bulb 10 is to replace). These determinations can be carried out with the use of fluid dynamics software, though hand calculations, experimentation and other manners of making the determinations can be used. If certain areas of the base 14 are determined to become hotter than surrounding areas, more material can be added to the hotter portions of the base 14 within the above mentioned constraints.

In one example in which the bulb 10 was configured to output the same amount of light as a 60 W incandescent bulb, ten columns of nodes 20 are spaced circumferentially around the base 14 and three rows of nodes 20 are spaced axially in each column to achieve sufficient heat dissipation for LEDs 18 of the surface-mountable type available from Nichia to use 11 W of power. Continuing with the example, the nodes 20 occupy approximately 70% of the circumferential surface area of the base 14 excluding the ridge 34, with the surface 21 and ridge 34 occupying the remaining approximately 30% of the circumferential surface area. The nodes 20 have a height of approximately 3 mm from the surface 21. The three nodes 20 in each column have different axial lengths, with the nodes 20 nearest to the platform 26 having an axial length of approximately 10 mm, the middle row of nodes 20 having an axial length of approximately 7 mm, and the nodes 20 nearest the electrical connector 12 having an axial length of approximately 4 mm. The circumferential spacing between the columns of nodes 20 and the axial spacing between the rows of nodes 20 are both approximately 4 mm. The thickness of the base 14 between the surface 21 and the cavity 32 is approximately 2 mm. The diameter of the cavity 32 is approximately 35 mm. Additional geometrical aspects of the base 14 are discussed below in respect of the ratio between the dimensions of the base 14 and the dimensions of the bulb 19. The base 14 can alternatively have a different geometry and still be suitable for use with LEDs 18 of the surface-mountable type available from Nichia that produce 11 W in the aggregate, and the base 14 can have a different geometry if it is intended to replace an incandescent light other than the 60 W incandescent bulb.

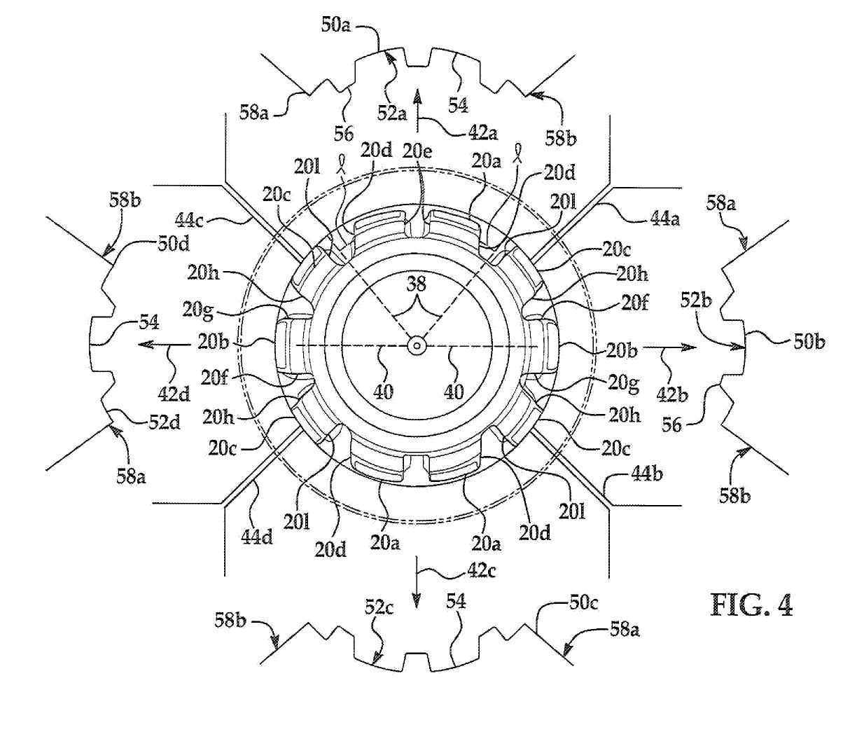

The base 14 can be manufactured by die casting, machining (e.g., milling or lathing), or using another process. Referring now to FIG. 4, when die casting the base 14, a die made from die pieces 50a-d that collectively define a mold cavity in the shape of the base 14 when assembled can be used. Each die piece 50a-d can have a respective face 52a-d corresponding to a shape of a portion of the base 14, such as a portion of the base 14 extending the entire axial length of the base 14 and circumferentially approximately a quarter of the circumference of the base 14. Each face 52a-d can define a plurality of indentations 54 in the shapes of nodes 20 and can define protrusions 56 that form the channels 22 and 24. Some of the indentations 54 and protrusions 56 can be partially defined by adjacent die pieces 50a-d such that those indentations 54 and protrusions 56 are fully defined when the die pieces 50a-d are assembled. Molten material can be inserted into the mold cavity and allowed to cool to form the base 14, and the die pieces 50a-d can be removed from the base 14 once the molten material is sufficiently cooled.

The geometry of the base 14 can allow for easy removal of the die pieces 50a-d from the base 14. For example, as shown in FIG. 4, the die pieces 50a-d can meet at junction lines 44a-d when assembled to form the complete mold cavity. Each die piece 50a-d can have two opposing sides 58a and 58b, and side 58a of each die piece 50a-d can contact the side 58b of an adjacent die piece 50a-d when the die pieces 50a-d are assembled. The die pieces 50a-d can be removed from the base 14 along respective pull lines 42a-d after the molten material poured into the mold cavity has sufficiently cooled to allow removal of the die pieces 50a-d.

To allow for removal of the die pieces 50a-d after formation of the base 14 without interference from the base 14, at least some of the nodes 20 can project from the surface 21 at an angle relative to radii of the base 14. For example, as shown in FIG. 4, three types of nodes 20a, 20b and 20c can be included on the base 14. Columns of the nodes 20a can be included on the base 14 in pairs that are circumferentially adjacent to one another. Two pairs of columns of nodes 20a are disposed on the example of the base 14 shown in FIG. 4, with the two pairs of nodes 20a being radially opposite one another about the base 14. Sides 20d on the circumferential outside of each pair of columns of nodes 20a can be angled by an angle α relative to radii 38 of the base 14 that pass through proximal ends of the sides 20d. The angles α can be large enough such that sides 20 are parallel to their respective pull lines 42a and 42c or larger. Sides 20e on the circumferential inside of each pair of columns of nodes 20a can be parallel to their respective sides 20d, or angled toward their respective sides 20d to form an acute angle with its vertex radially outward of the nodes 20a. Thus, the sides 20d and 20e of the nodes 20a allow die pieces 50a and 50c to be pulled away along pull lines 42a and 42c, respectively, without interference from the nodes 20a.

Still referring to the example shown in FIG. 4, two columns of nodes 20b are included on the base 14 at positions spaced by approximately ninety degrees from the pairs of columns of nodes 20a, with the two columns of nodes 20b being radially opposite one another relative to the base 14. The nodes 20b can have sides 20f and 20g that are parallel to one another and parallel to radii 40 of the base 14 passing through the circumferential centers of the nodes 20b. Sides 20f and 20g of each node 20b can extend generally parallel to a radius 40 of the base 14 passing through the circumferential center of the respective node. Sides 20f and 20g can be perpendicular to sides 20d of the nodes 20a. The angles of sides 20f and 20g allow for die pieces 50b and 50d to be removed along pull lines 42b and 42d, respectively, without interference from the nodes 20b.

Also in the example shown in FIG. 4, four columns of nodes 20c are included on the base 14, with each column of nodes 20c positioned circumferentially between one of the columns of nodes 20a and one of the columns of nodes 20b. Each node 20c can have sides 20h and 20i, with side 20h parallel to the nearest side 20f or 20g of the neighboring node 20b or angled away from that nearest side 20f or 20g as side 20h extends radially outward. Similarly, side 20i can be parallel to the side 20d of its neighboring node 20a or angled away from that side 20d as side 20i extends radially outward. The angles of sides 20i and 20h can allow die pieces 50a-d to be removed from the base 14 without interferences from the nodes 20b.

The die section boundaries 44a-44d can vary from the positions shown in FIG. 4 even if the geometry of the base 14 remains the same. For example, the boundary 44a could be moved circumferentially to almost the side 20i of the node 20c without detrimentally affecting removal of the die pieces 50a-d. Also, the angles of the sides 20d-20i of the nodes 20a, 20b and 20c can vary from as shown in FIG. 3, and the types of nodes 20a, 20b and 20c and number of each type of node 20a, 20b and 20c can vary depending on, for example, the number of columns of nodes 20a, 20b and 20c positioned about the base 14. Also, the number of die pieces 50a-d can vary and can be as few as two.

Referring back to FIGS. 1 and 2, the circuit board 16 can be of the type in which metalized conductor patterns are formed in a process known as “printing” to provide electrical connections between the wiring 27 and the LEDs 18 and between the LEDs 18 themselves. The metalized conductor pattern can be printed onto an electrically insulating board or, depending on the material of the base 14, directly onto the base 14. Alternatively, another type of circuit board 16 can be used. The circuit board 16 can be made from one piece or from multiple pieces joined by, for example, bridge connectors. The circuit board 16 can be annular shaped and can extend about the aperture 28 defined by the base 14, though the circuit board 16 can alternatively have a different shape (e.g., a pair of rectangular circuit boards 16 can be attached to the base 14 on radially opposite sides of the aperture 28). The circuit board 16 can be attached to the platform 26 using thermally conductive tape, screws, or another type of connector.

The LEDs 18 can be mounted on the circuit board 16 for electrical communication with the wiring 27. The LEDs 18 can be oriented to produce light centered about axes perpendicular to the platform 26 of the base 14. However, LEDs 18 can additionally or alternatively be oriented at other angles relative to the platform 26. The LEDs 18 can be high-power, white light emitting diodes, such as surface-mount devices of a type available from Nichia. The term “high-power” as used herein refers to LEDs 18 having power ratings of 0.25 watts or more. Indeed, the LEDs 18 can have power ratings of one watt or more. However, LEDs 18 with other power ratings, e.g., 0.05 W, 0.10 W, or 0.25 W, can alternatively be used. The number of LEDs 18 can depend on the intended use of the screw-in LED bulb 10. For example, if the screw-in LED bulb 10 is intended to replace a 60 W incandescent bulb, LEDs 18 with an aggregate power of 11 W can be used to produce a similar luminosity as the 60 W incandescent bulb. Although the LEDs 18 are shown as surface-mounted components, the LEDs 18 can be discrete components. Also, one or more organic LEDs can be used in place of or in addition to the surface-mounted LEDs 18. LEDs 18 that emit blue light, ultra-violet light or other wavelengths of light, such as wavelengths with a frequency of 400-790 THz corresponding to the spectrum of visible light, can alternatively or additionally be included.

The bulb 19 can be attached to the wall 30 of the base 14 using adhesive, though in other examples the bulb 19 can be screwed, snap-fit, or otherwise attached to the base 14. The bulb 19 can be made from a transparent or translucent material such as polycarbonate, acrylic, or glass. The bulb 19 can include a coating 23 to modify the transmissiveness of the bulb 19 by altering paths of light produced by the LEDs 18. The coating 23 can be a reflective coating, a diffusive coating, or another light path altering coating. The coating 23 can be denser on an area of the bulb 19 toward which a large amount of light is directed, such as a portion of the bulb 19 about a line extending axially from a center of the platform 26, compared to areas of the bulb 19 toward which a small amount of light is direct, such as portions of the bulb 19 near the wall 30. The coating 23 can prevent the appearance of a bright spot or a beam of light by scattering light rays and reducing the concentration of light rates in the bright spot area. The coating 23 can direct light in toward directions such as an area of the bulb 19 through which a low amount of light would pass were it not for the coating 23, e.g., an area of the bulb 19 near the wall 30. Alternatively to the coating 23, other types light diffracting structures, such as bumps, ridges, or dimples, can be formed in the bulb 19 at locations where bright spots are present.

Referring still to FIG. 1, the shape of the bulb 19 can affect the distribution of light from the screw-in LED bulb 10. For example, the shape of the bulb 19 can allow the screw-in LED bulb 10 to distribute light relatively evenly in most directions in order for the screw-in LED bulb 10 to closely replicate the appearance of an incandescent bulb. A diameter or width 46 of the bulb 19 measured perpendicularly to the axial direction of the base 14 can be about 120% or more of a maximum diameter 48 of the base 14, which is the diameter of the end 17 of the base 14 as shown in FIG. 1, and a height 53 of the bulb 19 measured along the axial direction of the base 14 from the platform 26 or end 17 of the base 14 can be about equal to the width 46 of the bulb 19 (e.g., the height 53 can be within 10% of the width 46 of the bulb 19) or greater than the width 46 of the bulb 19. Having the bulb 19 extend further than the base 14 in the radial direction as described above allows the bulb 19 to reflect light in directions that would otherwise be blocked by the base 14, such as in a direction toward the electrical connector 12. Having the height 53 of the bulb 19 set about equal to the width 46 of the bulb 19 or greater allows light a sufficient distance to spread out before encountering the bulb 19, which can aid in evening the distribution of light produced by the LEDs 18. Note that these dimensional ratios between the base 14 and the bulb 19 are also affected by the size constraints of the entire screw-in LED bulb 10 mentioned above. The dimensional ratios between the base 14 and bulb 19 can allow the screw-in LED bulb 10 to be positioned, for example, with the bulb 19 above the base 14 in a fixture such as a desk lamp, and the screw-in LED bulb 10 can produce light in a direction toward a desk on which the desk lamp sits.

In one example in which the screw-in LED bulb 10 is intended to replace a 60 W incandescent bulb, the maximum width 46 of the bulb 19 is 67.5 mm and the height of the bulb 19 is 68.5, while the maximum diameter 48 of the base 14 is 54.3 mm. The bulb 19 can have other dimensions when the screw-in LED bulb 10 is intended to replace the 60 W incandescent bulb, or when the screw-in LED bulb 10 is intended to replace some other bulb.

In another example of a screw-in LED bulb 60 shown in FIG. 5 having the same electric connector 12, circuit board 16, LEDs 18, and bulb 19 as the screw-in LED bulb 10, a base 62 defines diamond shaped nodes 20. The diamond shaped nodes 20 on the base 62 define channels 22 and 24 angled approximately forty five degrees relative to the axial and circumferential directions, respectively. The channels 22 and 24 allow airflow to travel in multiple directions, and the base 62 can dissipate a sufficient amount of heat for the LEDs 18 to produce an equivalent amount of light as a 60 W incandescent bulb.

The above-described examples have been described in order to allow easy understanding of the invention and do not limit the invention. On the contrary, the invention is intended to cover various modifications and equivalent arrangements, whose scope is to be accorded the broadest interpretation so as to encompass all such modifications and equivalent structure as is permitted under the law.

What is claimed:

1. An LED-based light comprising:
a highly thermally conductive base defining multiple radially outward projecting nodes, the nodes spaced apart in axial and circumferential directions of the base, the base including recessed channels between the nodes to enable airflow in multiple directions about the base;
an electrical connector attached to the base;
at least one LED attached to the base; and
a light transmitting bulb attached to the base and covering the at least one LED.

2. The LED-based light of claim 1, wherein groups of more than one adjacent nodes are associated with respective imaginary radial pull lines, and wherein sides of each node are angled as the node extends radially outward such that each side extends parallel to its respective pull line or is angled further toward an opposing side of the node than its respective pull line.

3. The LED-based light of claim 1, wherein the nodes are arranged in rows extending circumferentially about the base and in columns extending axially along the base.

4. The LED-based light of claim 1, wherein the channels include a first group of axially extending channels and a second ground of circumferentially extending channels.

5. The LED-based light of claim 1, wherein the nodes project from a surface of the base, and wherein the nodes have filleted edges at junctions between sides of the nodes and the surface and have rounded edges at junctions between sides of the nodes and distal ends of the nodes.

6. The LED-based light of claim 1, wherein a width of the bulb in a radial direction perpendicular to the axial direction of the base is at least 20% greater than a width of the base in the radial direction.

7. The LED-based light of claim 6, wherein the width of the bulb is at least 20% greater than a maximum width of the base in the radial direction.

8. The LED-based light of claim 6, wherein a height of the bulb in the axial direction of the base is as at least as great as the width of the bulb.

9. The LED-based light of claim 1, wherein the electrical connector is an Edison-type screw-in connector in electrical communication with the at least one LED.

10. The LED-based light of claim 1, wherein the base defines a cavity for housing electronics configured to convert a power received from the electrical connector to a power suitable for powering the at least one LED.

11. An LED-based light for use in a standard Edison-type screw-in fixture comprising:
a highly thermally conductive base defining multiple radially outward projecting nodes, wherein groups of more than one adjacent nodes are associated with respective imaginary radial pull lines, and wherein sides of each node are angled as the node extends radially outward such that each side extends parallel to its respective pull line or is angled further toward an opposing side of the node than its respective pull line;
an Edison-type screw-in electrical connector attached to the base;
at least one LED attached to the base; and
a light transmitting bulb attached to the base and covering the at least one LED.

12. The LED-based light of claim 11, wherein the nodes are arranged in rows extending circumferentially about the base and in columns extending axially along the base.

13. The LED-based light of claim 11, wherein the channels include a first group of axially extending channels and a second ground of circumferentially extending channels.

14. The LED-based light of claim 11, wherein the nodes project from a surface of the base, and wherein the nodes have filleted edges at junctions between sides of the nodes and the surface and have rounded edges at junctions between sides of the nodes and distal ends of the nodes.

15. The LED-based light of claim 11, wherein a width of the bulb in a radial direction perpendicular to the axial direction of the base is at least 20% greater than a width of the base in the radial direction.

16. The LED-based light of claim 15, wherein the width of the bulb is at least 20% greater than a maximum width of the base in the radial direction.

17. The LED-based light of claim 15, wherein a height of the bulb in the axial direction of the base is as at least as great as the width of the bulb.

18. The LED-based light of claim 11, wherein the electrical connector is an Edison-type screw-in connector in electrical communication with the at least one LED.

19. A method of providing power to a LED-based light having a highly thermally conductive base, an electrical connector attached to the base, at least one LED attached to the base, and a light transmitting bulb attached to the base and covering the at least one LED.
providing power to the at least one LED through the electrical connector connected attached to the base;
dissipating heat generated by the at least one LED using the base, wherein the base defines multiple radially outward projecting nodes, the nodes spaced apart in axial and circumferential directions of the base, and wherein the base includes recessed channels between the nodes to enable airflow in multiple directions about the base.

20. The method of claim 1, wherein groups of more than one adjacent nodes are associated with respective imaginary radial pull lines, and wherein sides of each node are angled as the node extends radially outward such that each side extends parallel to its respective pull line or is angled further toward an opposing side of the node than its respective pull line.
